(19) United States
(12) Patent Application Publication
(10) Pub. No.: US 2021/0194581 A1
(43) Pub. Date: Jun. 24, 2021

(54) INFORMATION PROCESSING DEVICE, METHOD AND MAINTENANCE TERMINAL

(71) Applicant: TOSHIBA TEC KABUSHIKI KAISHA, Tokyo (JP)

(72) Inventor: Takeshi Shimazaki, Sunto Shizuoka (JP)

(21) Appl. No.: 16/983,007

(22) Filed: Aug. 3, 2020

(30) Foreign Application Priority Data
Dec. 24, 2019 (JP) 2019-232966

(51) Int. Cl. H04B 10/116; G08B 7/06; H05B 45/00; G05B 13/02; G06Q 20/20

(52) U.S. Cl. CPC H04B 10/116; G08B 7/06; G06Q 20/20; G05B 13/026; H05B 45/00

(57) ABSTRACT

According to one embodiment, an information processing device includes an execution unit configured to execute processing based on a preset processing procedure, a prediction unit configured to predict an end time of the processing executed by the execution unit, and a transmission unit configured to control a light source device connected to the own device and to transmit the end time predicted by the prediction unit by visible light communication.

### CROSS-REFERENCE TO RELATED APPLICATION

This application is based upon and claims the benefit of priority from Japanese Patent Application No. 2019-232966, filed in Dec. 24, 2019, the entire contents of which are incorporated herein by reference.

### FIELD

Embodiments described herein relate generally to an information processing device, a method, and a maintenance terminal.

### BACKGROUND

In the related art, commodity sales data processing devices such as POS terminals (Point of Sales) have been used in stores such as supermarkets. Since the commodity sales data processing device is an information processing device that operates based on various data such as programs, it is possible to improve security and add functions by updating the data.

In the related art, there is a technique for transmitting an update program from a remote host computer to a terminal to remotely update data. On the other hand, there is an environment where it is not possible to connect to an external device or a network for security reasons or the like. In such a case, a maintenance person goes to the site and updates data manually.

Meanwhile, the data update processing is generally programmed to be automatically performed by the above-described update program or the like. Further, the data update processing may be performed for a relatively long time. Therefore, when the maintenance person updates the data on site, there is a demand to perform other work (for example, maintenance work of another POS terminal) in parallel until the update processing is completed.

However, according to the technique of the related art, it is difficult to easily grasp the end time of the data update, which makes it difficult to concentrate on other work. Further, in a store serving as a work site, since it may be difficult to connect to the network in the store for the above-described security reasons or the like, it is difficult to check the process status of the update processing over the network.

### DESCRIPTION OF THE DRAWINGS

FIG. 1 is a diagram illustrating an example of a maintenance system according to a first embodiment;

FIG. 2 is a diagram illustrating an example of a hardware configuration of a POS terminal according to the first embodiment;

FIG. 3 is a diagram illustrating an example of a hardware configuration of a server device according to the first embodiment;

FIG. 4 is a diagram illustrating an example of a hardware configuration of a maintenance terminal according to the first embodiment;

FIG. 5 is a diagram illustrating an example of a functional configuration of the maintenance system according to the first embodiment;

FIG. 6 is a flowchart illustrating an example of a process executed by the POS terminal according to the first embodiment;

FIG. 7 is a flowchart illustrating an example of a process executed by the server device according to the first embodiment;

FIG. 8 is a flowchart illustrating an example of a process executed by the maintenance terminal according to the first embodiment;

FIG. 9 is a diagram illustrating an example of a maintenance system according to a second embodiment;

FIG. 10 is a diagram illustrating an example of a hardware configuration of a server device according to the second embodiment; and

FIG. 11 is a diagram illustrating an example of a functional configuration of the server device according to the second embodiment.

### DETAILED DESCRIPTION

An object of the present disclosure is to provide an information processing device, a method, and a maintenance terminal that can perform maintenance work efficiently.

In general, according to one embodiment, an information processing device includes an execution means, a prediction means, and a transmission means. The execution means executes processing based on a preset processing procedure. The prediction means predicts an end time of the processing executed by the execution means. The transmission means controls a light source device connected to the own device and transmits the end time predicted by the prediction means by visible light communication.

Hereinafter, an information processing device, a method, and a maintenance terminal according to an embodiment will be described with reference to the drawings. Hereinafter, a POS terminal used in a store will be described as a device to be maintained. The present disclosure is not limited by the embodiments described below.

### First Embodiment

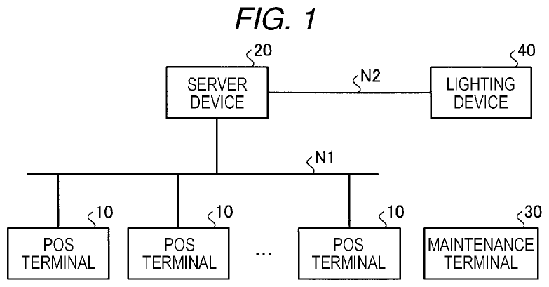

FIG. 1 is a diagram illustrating an example of a maintenance system according to the present embodiment. As shown in FIG. 1, a maintenance system 1 includes a POS terminal 10, a server device 20, and a maintenance terminal 30. Further, the maintenance system 1 includes a lighting device 40.

The POS terminal 10 and the server device 20 are connected via a network N1 such as a local area network (LAN) provided in the store. The server device 20 and the lighting device 40 are connected via a cable N2 such as a control line. That is, the POS terminal 10 and the lighting device 40 are connected via the server device 20. The number of POS terminals 10 and the number of lighting devices 40 are not limited to the example of FIG. 1.

The POS terminal 10 is provided in a checkout section in a store and performs a settlement process for a commodity purchased by a customer. In the present embodiment, the POS terminal 10 is a device to be maintained, and data is updated by a maintenance person as described later. In addition, the POS terminal 10 is not limited to a normal POS terminal operated by a store clerk but includes a self-service type POS terminal operated by a customer. In addition, the POS terminal 10 includes a semi-self-service type POS terminal in which a clerk operates sales registration and a customer performs a checkout operation.

The POS terminal 10 includes a clerk display unit 110 including a backlight 1101 described below. The POS terminal 10 can perform visible light communication by modulating the intensity of light emitted from the backlight 1101. In addition, the visible light communication can use a known and public technology.

The server device 20 is, for example, a store server placed in a store and receives various information transmitted from each of the POS terminals 10. The server device 20 is connected to the lighting device 40 and controls the light emission of the lighting device 40.

A plurality of lighting devices 40 are installed, for example, on the ceiling of the store and illuminate the entrance and exit of the store, display portions where commodities are displayed, the checkout section, and the like from above. The server device 20 can perform visible light communication by modulating the intensity of light emitted from the lighting device 40.

In the present embodiment, a light source device such as light emitting diode (LED) lighting is used as a light source of the backlight 1101 and the lighting device 40 described later. In the LED lighting, the modulation frequency can be set high in particular. Therefore, by using LED lighting as the light source of the backlight 1101 and the lighting device 40, the light intensity can be modulated in a high frequency band in which human eyes do not sense flickering.

The maintenance terminal 30 is an example of a maintenance terminal. The maintenance terminal 30 is carried by a maintenance person and used when performing maintenance work on the POS terminal 10. As the maintenance terminal 30, for example, a portable terminal device such as a smartphone or a tablet terminal can be used. The maintenance terminal can receive information transmitted by visible light communication by analyzing image data captured by an imaging unit 311 described below.

Next, the device configuration of the above-described maintenance system 1 will be described.

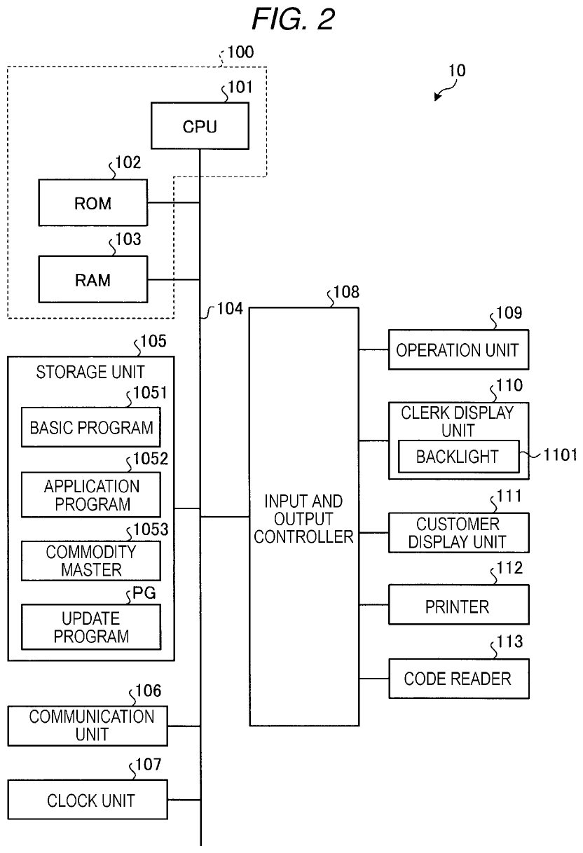

First, the hardware configuration of the POS terminal 10 will be described. FIG. 2 is a diagram illustrating an example of the hardware configuration of the POS terminal 10. As shown in FIG. 2, the POS terminal 10 includes a central processing unit (CPU) 101, a read only memory (ROM) 102, and a random access memory (RAM) 103.

The CPU 101 is an example of a processor and controls the operation of the POS terminal 10 in an integrated manner. The ROM 102 stores various programs. The RAM 103 is a workspace for loading programs and various data. The CPU 101, the ROM 102, and the RAM 103 are connected to each other via a bus 104. The CPU 101, the ROM 102, and the RAM 103 constitute a control unit 100 configuring a computer. In the control unit 100, the CPU 101 executes various processes by operating in accordance with a program stored in the ROM 102 or a storage unit 105 described later and loaded in the RAM 103.

The storage unit 105 is connected to the control unit 100 via the bus 104. The storage unit 105 is a storage device such as a solid state drive (SSD), a hard disk drive (HDD), and a flash memory, and retains the stored contents even when the power is turned off.

The storage unit 105 stores, for example, various data such as a basic program 1051, an application program 1052, a commodity master 1053, and the like. The basic program 1051 is a program for realizing the basic operation of the POS terminal 10, such as an operating system. The application program 1052 is a program for realizing a predetermined function related to a commercial transaction (for example, a function related to a settlement process). The commodity master 1053 is a database or the like that stores information on commodities sold in the store. For example, the commodity master 1053 stores various commodity information such as a commodity name and a unit price in association with a commodity code for identifying each commodity.

In the present embodiment, any or all of the data of the basic program 1051, the application program 1052, and the commodity master 1053 described above are updated as data to be updated by an operation of the maintenance person. Specifically, when an instruction to start execution of an update program PG is given by the maintenance person, the data to be updated is automatically updated according to a processing procedure programmed in advance in the update program PG. In FIG. 2, the storage unit 105 stores the update program PG, but the present disclosure is not limited thereto. For example, the server device 20 may store the update program PG, and the POS terminal 10 may execute the update program PG over the network N1.

Further, a communication unit 106 and a clock unit 107 are connected to the control unit 100 via the bus 104. The communication unit 106 is a wired or wireless communication interface that can be connected to the network N1. The communication unit 106 communicates with the server device 20 and the like via the network N1. The clock unit 107 is a clock device such as a real time clock (RTC). The clock unit 107 measures, for example, the current date and time. The date and time measured by the clock unit 107 is used for calculating an end time, which will be described later.

An operation unit 109, the clerk display unit 110, a customer display unit 111, a printer 112, a code reader 113, and the like are connected to the control unit 100 via the bus 104 and an input and output controller 108.

The operation unit 109 includes a keyboard including various operation buttons, a pointing device, and the like. The operation unit 109 receives an operation of the operator and outputs the content of the received operation to the control unit 100.

The clerk display unit 110 is a display device such as a liquid crystal display (LCD) including the backlight 1101. The backlight 1101 is configured by a light source device such as an LED as described above. The backlight 1101 can perform visible light communication by modulating light emitted by the light source device under the control of the control unit 100.

In addition, the clerk display unit 110 displays various screens, such as a screen related to the operation of the POS terminal 10, a screen related to the settlement process for a commodity, and a screen indicating the data update status, under the control of the control unit 100. The operation unit 109 may be, for example, a touch panel provided on a surface of the clerk display unit 110.

The customer display unit 111 is configured by a display device similar to the clerk display unit 110, for example. Under the control of the control unit 100, the customer display unit 111 displays a screen presented to the customer, such as a screen related to the settlement process for a commodity.

The printer 112 is, for example, a thermal printer including a thermal head. The printer 112 prints commodity information and information related to the settlement on long thermal paper to dispense a receipt. The code reader 113 is a reading device that reads a code symbol such as a bar code attached to a commodity. The code reader 113 receives an input of a commodity to be purchased by a customer by reading a commodity code held by the code symbol.

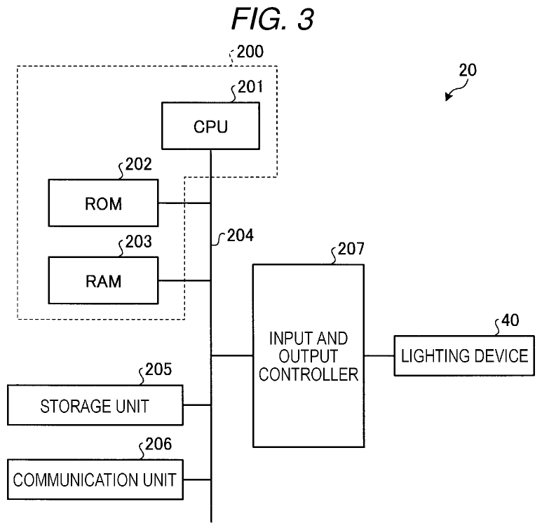

Next, a hardware configuration of the server device 20 will be described. FIG. 3 is a diagram illustrating an example of a hardware configuration of the server device 20. As shown in FIG. 3, the server device 20 includes a CPU 201, a ROM 202, and a RAM 203.

The CPU 201 is an example of a processor and controls the operation of the server device 20 in an integrated manner. The ROM 202 stores various programs. The RAM 203 is a workspace for loading programs and various data. The CPU 201, the ROM 202, and the RAM 203 are connected to each other via a bus 204. The CPU 201, the ROM 202, and the RAM 203 constitute a control unit 200 configuring a computer. In the control unit 200, the CPU 201 executes various processes by operating in accordance with a program stored in the ROM 202 or a storage unit 205 described later and loaded in the RAM 203.

The storage unit 205 and a communication unit 206 are connected to the control unit 200 via the bus 204. The storage unit 205 is a storage device such as an SSD, an HDD, and a flash memory, and retains the stored contents even when the power is turned off. The storage unit 205 stores various programs executed by the CPU 201 and setting information. The communication unit 206 is a wired or wireless communication interface that can be connected to the network N1. The communication unit 206 communicates with the POS terminal 10 and the like via the network N1.

The lighting device 40 is connected to the control unit 200 via the bus 204 and an input and output controller 207. The lighting device 40 includes a light source device such as an LED lighting as described above. The lighting device 40 can perform visible light communication by modulating light emitted from the light source device under the control of the control unit 200.

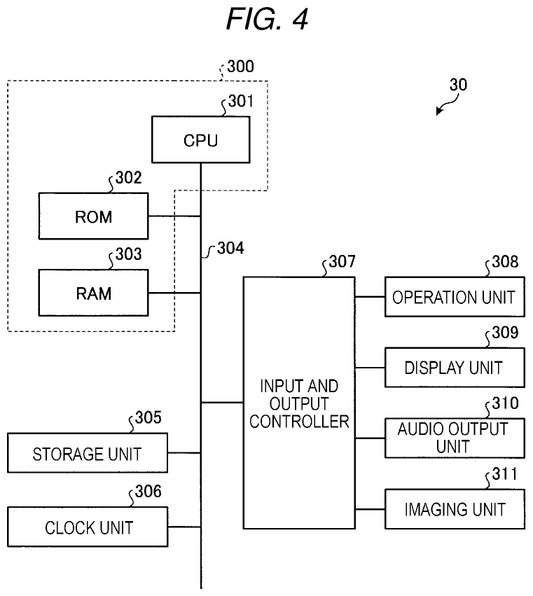

Next, the hardware configuration of the maintenance terminal 30 will be described. FIG. 4 is a diagram illustrating an example of a hardware configuration of the maintenance terminal 30. As shown in FIG. 4, the maintenance terminal 30 includes a CPU 301, a ROM 302, and a RAM 303.

The CPU 301 is an example of a processor and controls the operation of the maintenance terminal 30 in an integrated manner. The ROM 302 stores various programs. The RAM 303 is a workspace for loading programs and various data. The CPU 301, the ROM 302, and the RAM 303 are connected to each other via a bus 304. The CPU 301, the ROM 302, and the RAM 303 constitute a control unit 300 configuring a computer. In the control unit 300, the CPU 301 executes various processes by operating in accordance with a program stored in the ROM 302 or a storage unit 305 described below and loaded in the RAM 303.

The storage unit 305 and a clock unit 306 are connected to the control unit 300 via the bus 304. The storage unit 305 is a storage device such as an SSD, an HDD, and a flash memory, and retains the stored contents even when the power is turned off. The storage unit 305 stores various programs executed by the CPU 301 and setting information. The clock unit 306 is a clock device such as an RTC. The clock unit 306 measures, for example, the current date and time. The date and time measured by the clock unit 306 is used for alarm notification and the like described later.

Further, an operation unit 308, a display unit 309, an audio output unit 310, the imaging unit 311 and the like are connected to the control unit 300 via the bus 304 and an input and output controller 307.

The operation unit 308 includes a keyboard including various operation buttons, a pointing device, and the like. The operation unit 308 receives an operation of the operator and outputs the content of the received operation to the control unit 300. The display unit 309 is a display device such as an LCD. The display unit 309 displays various screens under the control of the control unit 300. The operation unit 308 may be, for example, a touch panel provided on the surface of the display unit 309. The audio output unit 310 is an audio output device, such as a speaker, that can output audio. The audio output unit 310 outputs audio such as an alarm sound under the control of the control unit 300.

The imaging unit 311 is an imaging device including an image sensor such as a charge coupled device (CCD) or a complementary MOS (CMOS). The imaging unit 311 outputs image data obtained by imaging to the control unit 300.

In the present embodiment, the imaging unit 311 captures a moving image as image data. The imaging unit 311 is used to receive light emitted by the clerk display unit 110 (backlight 1101) and the lighting device 40. A configuration may be adopted in which a light receiving device for visible light communication is provided instead of the imaging unit 311.

Next, a functional configuration of the maintenance system 1 will be described.

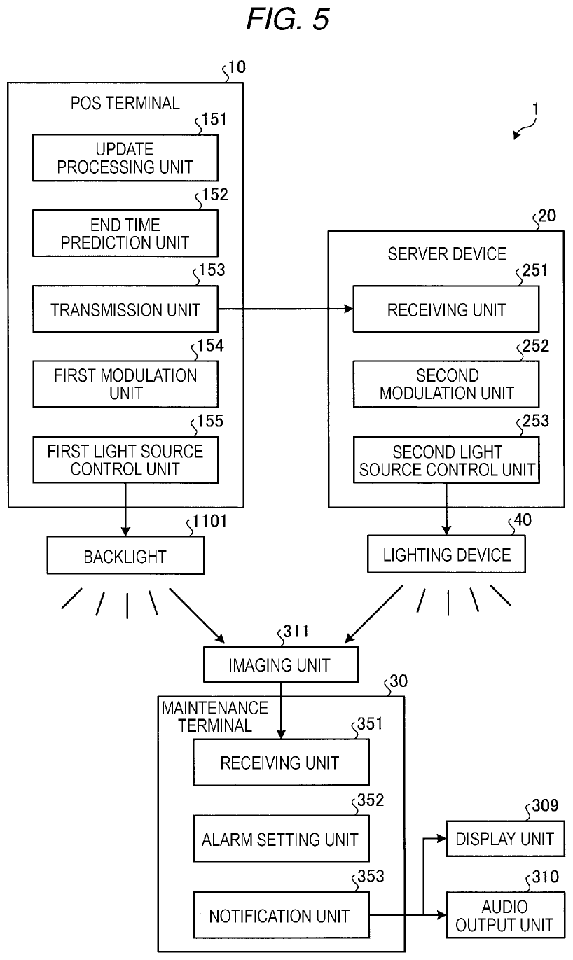

FIG. 5 is a diagram illustrating an example of a functional configuration of the maintenance system 1. In FIG. 5, the relationship between the functional units related to each device is indicated by an arrow. In FIG. 5, for convenience of explanation, the functional units provided in each device are described inside the device and the hardware configuration provided in each device is described outside the device.

As shown in FIG. 5, the POS terminal 10 includes an update processing unit 151, an end time prediction unit 152, a transmission unit 153, a first modulation unit 154, and a first light source control unit 155 as functional units. These functional units are activated when the POS terminal 10 is shifted to a maintenance mode for maintenance work by a predetermined operation via the operation unit 109, for example.

Some or all of the above-described functional units may have a software configuration realized by cooperation between a processor (for example, CPU 101) of the POS terminal 10 and a program stored in a memory (for example, ROM 102, storage unit 105). For example, some or all of the functional units described above may be realized by the basic program. 1051, the update program PG, or the like. Further, some or all of the functional units described above may have a hardware configuration realized by a dedicated circuit or the like mounted on the POS terminal 10.

The update processing unit 151 is an example of an execution unit. The update processing unit 151 executes update processing for updating data to be updated in cooperation with the update program PG. Specifically, the update processing unit 151 performs update processing of data to be updated by executing various processes related to data update based on a processing procedure programmed in advance in the update program PG.

The end time prediction unit 152 predicts the end time of the update processing executed by the update processing unit 151. The method of predicting the end time is not particularly limited, and various methods can be adopted.

For example, when the required time necessary for the update processing is set in advance in the update program PG, the end time prediction unit 152 may predict the required time set in the update program PG as the end time. In addition, the end time prediction unit 152 may predict, as the end time, the time obtained by adding the required time set in the update program PG to the time at which the update processing is started.

Further, for example, the end time prediction unit 152 may predict the time required until the update processing ends from the progress status of the update processing or the like as the end time in cooperation with the update processing unit 151. In addition, the end time prediction unit 152 may predict, as the end time, the time obtained by adding the required time predicted from the progress status or the like to the time at which the update processing is started.

The end time prediction unit 152 predicts the end time at least at the timing at which the update processing is started. However, it is preferable that the end time prediction unit 152 predicts (updates) the end time at predetermined intervals while the update processing unit 151 is executing the update processing. For example, the end time prediction unit 152 may predict the end time derived from the required time set in the update program PG at the timing when the update processing is started, and then predicts (update) the end time based on the progress status of the update processing and the like. Thus, the end time can be updated in accordance with the progress status of the update processing, and thus, a more accurate end time can be predicted.

The transmission unit 153 transmits the end time predicted by the end time prediction unit 152 to the server device 20. As will be described later, the end time transmitted to the server device 20 is transmitted by visible light communication via the lighting device 40 under the control of the server device 20.

The first modulation unit 154 generates a control signal for transmitting the end time predicted by the end time prediction unit 152 by visible light communication. Specifically, the first modulation unit 154 superimposes information indicating the end time predicted by the end time prediction unit 152 on a control signal for controlling the light emission of the backlight 1101, thereby generating a control signal for visible light communication.

The first light source control unit 155 controls light emission of the backlight 1101 based on the control signal generated by the first modulation unit 154. The first light source control unit 155 controls the light emission of the backlight 1101 to transmit the end time predicted by the end time prediction unit 152 by visible light communication.

The information transmitted from the POS terminal 10 to the server device 20 and the information transmitted via the backlight 1101 are not limited to the end time. For example, the transmission unit 153 and the first modulation unit 154 may control to transmit, together with the end time, a command for automatically setting an alarm at a time corresponding to the end time. Further, for example, the transmission unit 153 and the first modulation unit 154 may control to transmit, together with the end time, information (for example, a terminal ID or the like) for identifying the own POS terminal 10.

The server device 20 includes a receiving unit 251, a second modulation unit 252, and a second light source control unit 253 as functional units.

Some or all of the functional units described above may have a software configuration realized by cooperation between a processor (for example, CPU 201) of the server device 20 and a program stored in a memory (for example, ROM 202, storage unit 205). In addition, some or all of the functional units described above may have a hardware configuration realized by a dedicated circuit or the like mounted on the server device 20.

The receiving unit 251 receives information transmitted from the POS terminal 10. Specifically, the receiving unit 251 receives the end time transmitted from the transmission unit 153 of the POS terminal 10.

The second modulation unit 252 generates a control signal for transmitting the end time received by the receiving unit 251 by visible light communication. Specifically, the second modulation unit 252 superimposes information indicating the end time received by the receiving unit 251 on a control signal for controlling the light emission of the lighting device 40, thereby generating a control signal for the visible light communication.

The second light source control unit 253 controls the light emission of the lighting device 40 based on the control signal generated by the second modulation unit 252. The second light source control unit 253 controls the light emission of the lighting device 40 to transmit the end time received by the receiving unit 251, that is, the end time of the update processing predicted by the POS terminal 10 by visible light communication.

The maintenance terminal 30 includes a receiving unit 351, an alarm setting unit 352, and a notification unit 353 as functional units.

Some or all of the functional units described above may have a software configuration realized by cooperation between a processor (for example, CPU 301) of the maintenance terminal 30 and a program stored in a memory (for example, ROM 302, storage unit 305). Further, some or all of the functional units described above may have a hardware configuration realized by a dedicated circuit or the like mounted on the maintenance terminal 30.

The receiving unit 351 receives the information transmitted by visible light communication by analyzing the image data captured by the imaging unit 311. Specifically, the receiving unit 351 receives information superimposed on the light by analyzing the intensity of the light received by the imaging unit 311.

For example, when the clerk display unit 110 is imaged by the imaging unit 311, the receiving unit 351 analyzes the intensity of light emitted from the backlight 1101 captured in a moving image and receives the end time superimposed on the light. In addition, for example, when the lighting device 40 is imaged by the imaging unit 311, the receiving unit 351 analyzes the intensity of light emitted from the lighting device 40 captured in a moving image and receives the end time superimposed on the light.

The alarm setting unit 352 sets an alarm for notifying the end time received by the receiving unit 351. For example, when the end time indicates a period such as 10 minutes, the alarm setting unit 352 sets an alarm at a time obtained by adding the period indicated by the end time to the current time. In addition, for example, when the end time specifies a time, the alarm setting unit 352 sets an alarm at the specified time. When a command related to alarm setting is received along with the end time, the alarm setting unit 352 may set an alarm according to the command.

The notification unit 353 performs various notifications using the display unit 309, the audio output unit 310, and the like. For example, the notification unit 353 causes the display unit 309 to display a screen for notifying the end time received by the receiving unit 351. In addition, when the time when the alarm is set by the alarm setting unit 352 is reached, the notification unit 353 sounds the audio output unit 310 or displays a screen on the display unit 309 to notify that the end time is reached.

When the terminal ID of the transmission source POS terminal 10 is included together with the end time, the notification unit 353 may display the terminal ID on the display unit 309 in association with the end time or the like. Accordingly, the notification unit 353 can make the maintenance person recognize which POS terminal 10 is performing the update processing, and thus, the convenience can be improved in the case of updating a plurality of POS terminals 10 in parallel.

In addition, the notification unit 353 may perform notification using a unit other than the display unit 309 and the audio output unit 310. For example, when the maintenance terminal 30 includes a vibration generation device such as a vibrator, the notification unit 353 may notify that the alarm set time is reached by vibrating the vibration generation device.

As described above, in the maintenance system 1, when the update program PG is started by the POS terminal 10 by the maintenance person, the end time of the update processing is predicted and the predicted end time is transmitted via the clerk display unit 110 and the lighting device 40 by visible light communication. For this reason, the maintenance person points the imaging unit 311 of the maintenance terminal 30 owned by the maintenance person toward the clerk display unit 110 or the lighting device 40, thereby inputting the predicted end time to the maintenance terminal 30.

Accordingly, in the maintenance system 1, even in an environment where the maintenance terminal 30 cannot be connected to the network N1 or the POS terminal 10 for security reasons or the like, the end time predicted by the POS terminal 10 can be transferred to the maintenance terminal 30.

Further, the maintenance terminal 30 displays the end time received by the visible light communication on the display unit 309 and sets an alarm at a time corresponding to the end time. Then, when the alarm set time is reached, the maintenance terminal 30 notifies that the end time of the update processing is reached.

Thereby, the maintenance person can easily recognize, via the maintenance terminal 30, the end time of the update processing being executed on the POS terminal 10 and the timing when the end time is reached. Therefore, the maintenance person can make an action plan when performing other work in parallel and can concentrate on other work until the update processing is completed. In addition, since the maintenance person can perceive that the end time of the update processing is reached by sounding or the like, for example, when performing additional work on the POS terminal 10 after the data update, it is possible to quickly shift to the additional work.

In addition, in the maintenance system 1, since the end time predicted by the POS terminal 10 can be transmitted using the in-store lighting device 40, the end time can be received at any position in the store. Thus, the maintenance person can check the end time of the update processing using the maintenance terminal 30 even when performing other work at a position away from the POS terminal 10 that is executing the update processing. Therefore, the maintenance person can concentrate on other work.

Hereinafter, an operation example of the above-described maintenance system 1 will be described.

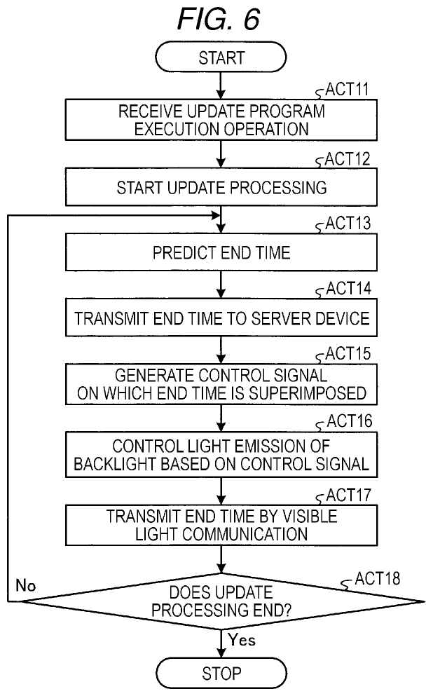

First, an operation example of the POS terminal 10 will be described with reference to FIG. 6. FIG. 6 is a flowchart illustrating an example of a process executed by the POS terminal 10. It is assumed that the POS terminal 10 is operating in the maintenance mode as a premise of this processing.

First, when the update processing unit 151 receives an instruction of operation to start execution of the update program PG via the operation unit 109 (ACT 11), the update processing unit 151 starts update processing of data to be updated based on the update program PG (ACT 12).

The end time prediction unit 152 predicts the end time at which the update processing ends based on the progress status of the update processing, and the like (ACT 13). Next, the transmission unit 153 transmits the end time predicted in ACT 13 to the server device 20 to transmit the end time by visible light communication via the lighting device 40 (ACT 14).

In addition, the first modulation unit 154 generates a control signal for visible light communication on which the end time predicted in ACT 13 is superimposed (ACT 15). The first light source control unit 155 controls the light emission of the backlight 1101 based on the control signal generated in ACT 15 (ACT 16), thereby transmitting the end time by visible light communication via the backlight 1101 (ACT 17).

Subsequently, the end time prediction unit 152 determines whether or not the update processing ended (ACT 18). If it is determined that the update processing is ongoing (ACT 18; No), the end time prediction unit 152 returns to ACT 13 to repeatedly predict the end time while executing the update processing. The end time prediction unit 152 may be configured to perform the end time prediction at predetermined time intervals by checking the end of the update processing at predetermined time intervals (for example, 30 seconds).

If it is determined in ACT 18 that the update processing ended (ACT 18; Yes), the processing ends. The end time prediction unit 152 may notify the end of the update processing by visible light communication in cooperation with the transmission unit 153 and the first modulation unit 154 along with the end of the update processing.

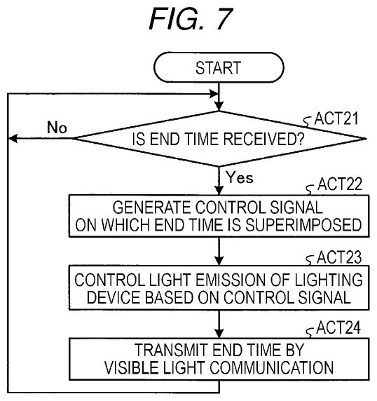

Next, an operation example of the server device 20 will be described with reference to FIG. 7. FIG. 7 is a flowchart illustrating an example of a process performed by the server device 20.

First, the receiving unit 251 waits until the end time is transmitted from the POS terminal 10 (ACT 21; No). Upon receiving the end time from the POS terminal 10 (ACT 21; Yes), the receiving unit 251 causes the process to proceed to ACT 22.

Subsequently, the second modulation unit 252 generates a control signal for visible light communication on which the end time received in ACT 21 is superimposed (ACT 22). Next, the second light source control unit 253 controls the light emission of the lighting device 40 based on the control signal generated in ACT 22 (ACT 23), thereby transmitting the end time by visible light communication via the lighting device 40 (ACT 24). Then, the second light source control unit 253 returns the process to ACT 21.

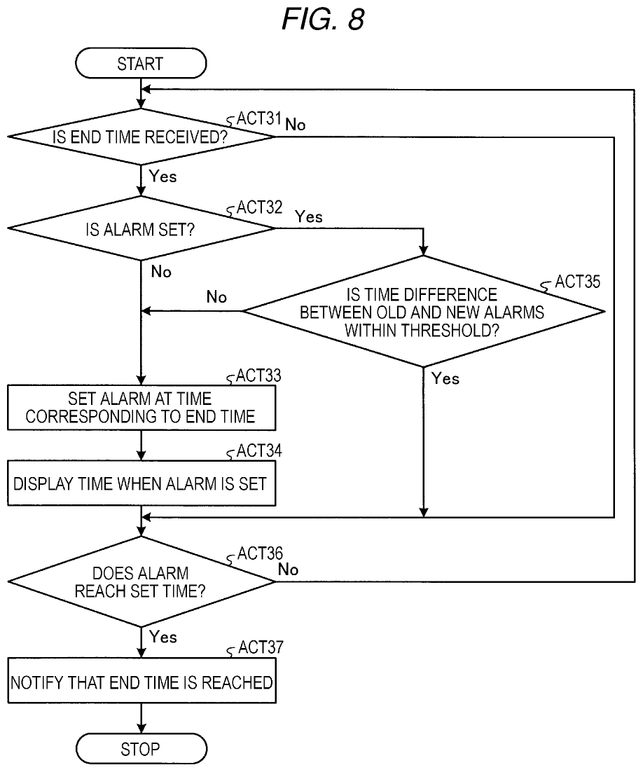

Next, an operation example of the maintenance terminal 30 will be described with reference to FIG. 8. FIG. 8 is a flowchart illustrating an example of a process executed by the maintenance terminal 30.

First, the receiving unit 351 determines whether the end time based on the image data captured by the imaging unit 311 was received (ACT 31). Here, when it is determined that the end time was not received (ACT 31; No), the process proceeds to ACT 36.

If the receiving unit 351 determines that the end time was received (ACT 31; Yes), the process proceeds to ACT 32. Next, the alarm setting unit 352 determines whether or not an alarm was set (ACT 32). If the alarm was not set, the alarm setting unit 352 sets the alarm at the time corresponding to the end time received in ACT 31 (ACT 33). In addition, the notification unit 353 notifies the maintenance person of the end time of the update processing by displaying the time when the alarm is set on the display unit 309 (ACT 34), and the process proceeds to ACT 36.

If the alarm setting unit 352 determines that the alarm was set in ACT 32 (ACT 32; Yes), the alarm setting unit 352 determines whether or not the difference between the set time and the time corresponding to the end time newly received in ACT 32 is within a threshold (for example, one minute) (ACT 35).

Here, if the time difference exceeds the threshold (ACT 35; No), the alarm setting unit 352 proceeds to ACT 33 and resets the alarm based on the newly received end time, thereby updating the time to set the alarm. If the time difference is within the threshold (ACT 35; Yes), the time at which the alarm is set is maintained and the process proceeds to ACT 36.

Subsequently, in ACT 36, the notification unit 353 determines whether or not the current time reached the time when the alarm was set (ACT 36). Here, when the alarm itself was not set or when the alarm did not reach the set time (ACT 36; No), the notification unit 353 returns the process to ACT 31.

On the other hand, when it is determined that the time at which the alarm was set was reached (ACT 36; Yes), the notification unit 353 notifies the maintenance person via the audio output unit 310 or the like that the end time of update processing was reached (ACT 37) and the processing ends.

As described above, in the maintenance system 1, when the update processing is executed on the POS terminal 10, the end time at which the update processing ends is predicted, and the predicted end time is transmitted by the visible light communication via the backlight 1101 or the lighting device 40. Further, in the maintenance system 1, when the maintenance terminal 30 receives the end time transmitted by the visible light communication, the maintenance terminal 30 sets an alarm at a time corresponding to the end time and notifies when the time is reached.

According to such a maintenance system. 1, it is possible to notify the maintenance person who owns the maintenance terminal 30 of the end time of the update processing being executed on the POS terminal 10 and the timing at which the end time is reached. Thereby, the maintenance system 1 can improve the convenience when the maintenance person waits for the end of the update processing or when other work is performed in parallel, and thus, the efficiency of the maintenance work can be improved.

Further, according to the maintenance system 1, by performing visible light communication using the backlight 1101 or the lighting device 40, it is possible to transmit the end time predicted by the POS terminal 10 to the maintenance terminal 30 without connecting the maintenance terminal 30 to the network N1. Thus, even in an environment where the maintenance terminal 30 cannot be connected to the network N1 or the POS terminal 10, the end time predicted by the POS terminal 10 can be transmitted to the maintenance terminal 30. Therefore, the maintenance person can acquire the end time predicted by the POS terminal 10 at the maintenance terminal 30 by imaging the clerk display unit 110 and the lighting device without performing the procedure related to the communication with the POS terminal 10. Therefore, the efficiency of maintenance work can be improved.

### Second Embodiment

Next, a second embodiment will be described. In the first embodiment described above, the case where the POS terminal 10 transmits the end time to the server device 20 via the network N1 is described. However, the method of transmitting the end time to the server device 20 is not limited thereto. Therefore, in the present embodiment, a mode in which the end time is transmitted to the server device 20 using visible light communication will be described as an example of another transmission method. The same components as those of the first embodiment are denoted by the same reference numerals and the description thereof is omitted.

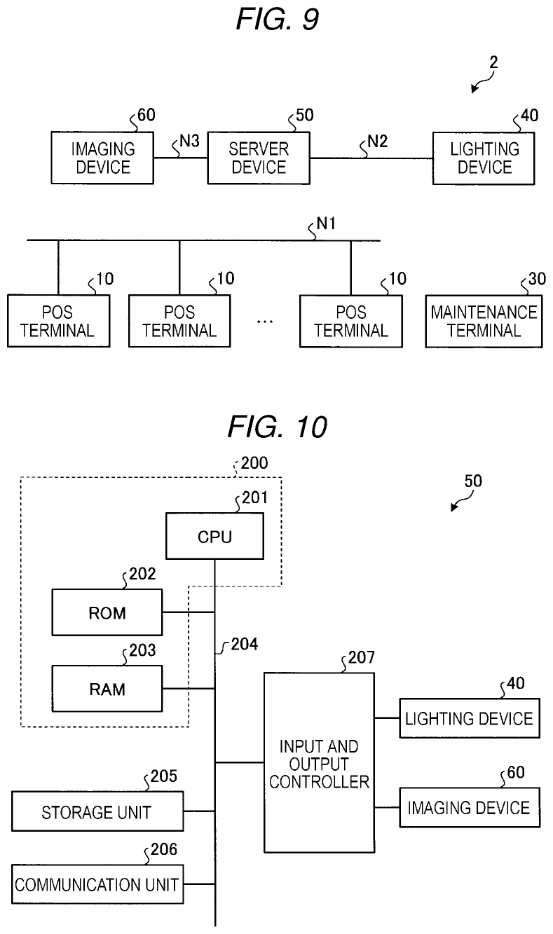

FIG. 9 is a diagram illustrating an example of a maintenance system according to the present embodiment. As shown in FIG. 9, a maintenance system 2 includes the POS terminal 10, a server device 50, the maintenance terminal 30, and the lighting device 40. Further, the maintenance system 2 includes an imaging device 60. Here, the server device 50 and the lighting device 40 are connected via the cable N2 such as a control line. The server device 50 and the imaging device 60 are connected via a cable N3 such as a data transmission line. In the present embodiment, it is assumed that the server device 50 is disconnected from the network N1.

The imaging device 60 is an imaging device including an image sensor such as a CCD or a CMOS. The imaging device 60 is, for example, a monitoring camera or the like installed on the ceiling or the like in an area where the POS terminal 10 is provided, and can image at least the clerk display unit 110 provided in the POS terminal 10.

In the present embodiment, the imaging device 60 captures a moving image as image data. The imaging device 60 is used for receiving light emitted by the clerk display unit 110 (backlight 1101). Instead of the imaging device 60, a light receiving device for visible light communication may be included.

The server device 50 is a device corresponding to the server device 20 of the first embodiment described above. The server device 50 has, for example, a hardware configuration illustrated in FIG. 10. Here, FIG. 10 is a diagram illustrating an example of a hardware configuration of the server device 50.

As shown in FIG. 10, the server device 50 includes the control unit 200 having a computer configuration such as the CPU 201, the ROM 202, and the RAM 203. Further, the storage unit 205 and the communication unit 206 are connected to the control unit 200 via the bus 204. The lighting device 40 and the imaging device 60 are connected to the control unit 200 via the bus 204 and the input and output controller 207 and the like. Image data captured by the imaging device 60 is input to the control unit 200.

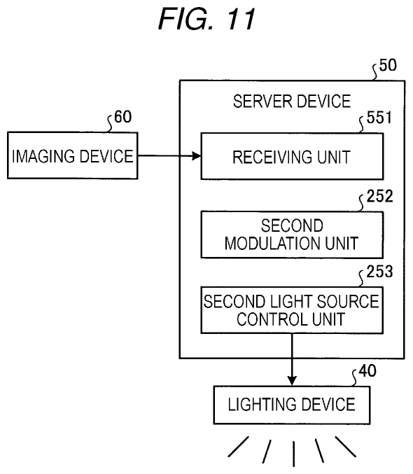

The server device 50 has, for example, a functional configuration illustrated in FIG. 11. Here, FIG. 11 is a diagram illustrating an example of a functional configuration of the server device 50.

As illustrated in FIG. 11, the server device 50 includes a receiving unit 551, the second modulation unit 252, and the second light source control unit 253 as functional units.

Here, the receiving unit 551 is a functional unit replacing the receiving unit 251 described above. The receiving unit 551 receives information transmitted by visible light communication by analyzing the image data captured by the imaging device 60. Specifically, the receiving unit 551 receives the information superimposed on the light by analyzing the intensity (vibration) of the light received by the imaging device 60.

For example, the receiving unit 551 receives the end time superimposed on the light by analyzing the intensity of light emitted from the backlight 1101 of the clerk display unit 110 from the image data of the clerk display unit 110 captured by the imaging device 60. That is, the POS terminal 10 and the server device 50 of this embodiment exchange the end time by visible light communication.

The second modulation unit 252 performs the same operation as that of the above-described first embodiment based on the end time received by the receiving unit 551. Thus, the server device 50 can transmit the end time of the update processing being executed on the POS terminal 10 to the maintenance terminal 30 by visible light communication via the lighting device 40, similarly to the server device 20.

Next, an operation example of the server device 50 will be described with reference to the above-described flowchart of FIG. 7.

First, the receiving unit 551 monitors the image data captured by the imaging device 60 and waits until an end time is transmitted by visible light communication (ACT 21; No). Upon receiving the end time from the imaging result of the imaging device 60 (ACT 21; Yes), the receiving unit 551 shifts the process to ACT 22. Subsequent processes in ACT 22 to ACT 24 are the same as those in FIG. 7.

As described above, according to the present embodiment, the end time information can be transmitted from the POS terminal 10 to the server device 50 using visible light communication. Thus, for example, even when the POS terminal 10 operates in a stand-alone manner in accordance with the updating processing, it is possible to notify the server device 50 of the end time information. Thus, the same effect as in the above-described embodiment can be obtained.

Further, when the configuration of the present embodiment is adopted, the transmission unit 153 of the POS terminal 10 becomes unnecessary, and thus, the transmission unit 153 may be made invalid or removed from the POS terminal 10.

The above-described embodiments (first and second embodiments) can be appropriately modified and implemented by partially changing the configuration or function of each device described above. Therefore, hereinafter, some modifications related to the above-described embodiments will be described as other embodiments. In the following, points different from the above-described embodiments will be mainly described, and the detailed descriptions of points common to the already described contents will be omitted. Further, the modifications described below may be implemented individually or may be implemented in combination as appropriate.

(Modification 1)

In the above-described embodiment, an example in which LEDs are used as the light sources of the backlight 1101 and the lighting device 40 is described, but the type of the light source is not limited thereto. However, it is preferable to use a light source that can be modulated in a high frequency band where human eyes do not sense flickering.

In the above-described embodiment, an example in which visible light communication is performed using the backlight 1101 of the clerk display unit 110 is described. However, the light source of the POS terminal 10 used for visible light communication is not limited thereto. For example, visible light communication may be performed using the backlight of the customer display unit 111. For example, visible light communication may be performed using a light source such as an indicator lamp included in a device such as the printer 112.

(Modification 2)

In the above-described embodiment, the POS terminal 10 performs the visible light communication using both the clerk display unit 110 (backlight 1101) and the light source device of the lighting device 40 connected to the own device. However, the present disclosure is not limited to this configuration, and the POS terminal 10 may be configured to perform visible light communication using one of the light source devices of the clerk display unit 110 (backlight 1101) and the lighting device 40.

In this case, for example, the control unit 100 of the POS terminal 10 may cause the clerk display unit 110 to display a selection screen for selecting a light source device used for visible light communication from the light source devices such as the backlight 1101 and the lighting device 40 connected to the own device. Then, the transmission unit 153, the first modulation unit 154, and the first light source control unit 155 may perform control such that visible light communication is performed using the light source device selected on the selection screen.

(Modification 3)

In the above-described embodiment, the case where the data update of one POS terminal 10 is performed is described. However, the same can be applied to the case where the data update of a plurality of POS terminals 10 is performed. In this case, it is assumed that each of the POS terminals 10 transmits the terminal ID capable of identifying the own POS terminal 10, together with the end time. In addition, the alarm setting unit 352 of the maintenance terminal 30 sets an alarm for each terminal ID transmitted together with the end time, thereby individually notifying the end time of the update processing being executed in each of the POS terminals 10.

(Modification 4)

In the above-described embodiment, the case where the data update processing is performed is described as an example, but the processing to be executed is not limited to the data update processing. Specifically, the type of the processing is not particularly limited as long as the processing is automatically executed by the POS terminal 10 for a relatively long time after the maintenance person performs the operation to start the processing.

In the above-described embodiment, the processing executed by the POS terminal 10 is described as an example. However, the information processing device that executes the processing is not limited to the POS terminal 10. For example, the same system configuration and device configuration as in the above-described embodiment may be adopted for the data update processing and other processing executed by the server device 20 or an information processing device such as a personal computer (PC) (not shown).

(Modification 5)

In the above-described embodiment, the POS terminal 10 performs the visible light communication by the lighting device 40 via the server device 20. However, the present disclosure is not limited thereto, and the POS terminal 10 may directly control the light emission of the lighting device 40. In this case, for example, the POS terminal 10 and the lighting device 40 are connected via a control line or the like, and the first modulation unit 154 and the first light source control unit 155 perform visible light communication using the lighting device 40. Thereby, since the setting contents of the setting change operation performed by the POS terminal 10 can be transmitted to the maintenance terminal 30 by visible light communication by the lighting device 40, the same effect as in the above-described embodiment can be obtained.

When the configuration of the present modification is adopted, the transmission unit 153 of the POS terminal 10 is not required, and thus the transmission unit 153 may be invalidated or removed from the POS terminal 10.

The program executed by each device of the above-described embodiments is provided by being incorporated in a ROM or the like in advance. The program executed by each device of the above-described embodiments may be provided by being recorded on a computer readable recording medium such as a CD-ROM, a flexible disk (FD), a CDR, and a digital versatile disk (DVD) in an installable format or an executable format file.

Furthermore, the program executed by each device of the above-described embodiments may be stored on a computer connected to a network such as the Internet and may be provided by being downloaded via the network. Further, the program executed by each device of the above-described embodiments may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
an execution component for executing processing based on a preset processing procedure;
a prediction component for predicting an end time of the processing executed by the execution component; and
a transmission component for controlling a light source device connected to the information processing device and to transmit the end time predicted by the prediction component by visible light communication.

2. The information processing device according to claim 1, wherein
the prediction component updates the end time according to a status of the processing executed by the execution component.

3. The information processing device according to claim 1, wherein
the transmission component controls the light source device included in a display device connected to the information processing device and transmits the end time predicted by the prediction component by the visible light communication.

4. The information processing device according to claim 1, wherein
the transmission component controls the light source device included in a lighting device in a store where the information processing device is provided and transmits the end time predicted by the prediction component by the visible light communication.

5. The information processing device according to claim 1, wherein
the prediction component at least one of:
predicts a time required until an update processing ends from a progress status of the update processing as the end time in cooperation with an update processing component; or
predict, as the end time, a time obtained by adding a required time predicted from the progress status to a time at which the update processing is started.

6. The information processing device according to claim 1, wherein
the light source device is a light emitting diode.

7. The information processing device according to claim 1, further comprising:
a real time clock.

8. The information processing device according to claim 1, wherein
the information processing device comprises a POS terminal.

9. The information processing device according to claim 1, wherein
the information processing device comprises a plurality of POS terminals and a server.

10. A method causing a computer of an information processing device to perform functions comprising:
executing processing based on a preset processing procedure;
predicting an end time of the processing executed; and
controlling a light source device connected to the information processing device and transmitting the end time predicted by visible light communication.

11. The method according to claim 10, further comprising:
updating the end time according to a status of the processing executed.

12. The method according to claim 10, further comprising:
controlling the light source device included in a display device connected to the information processing device and transmitting the end time predicted by the visible light communication.

13. The method according to claim 10, further comprising:
controlling the light source device included in a lighting device in a store where the information processing device is provided and transmitting the end time predicted by the visible light communication.

14. The method according to claim 10, further comprising:
predicting a time required until an update processing ends from a progress status of the update processing as the end time in cooperation with an update processing component.

15. The method according to claim 10, further comprising:
predicting, as the end time, a time obtained by adding a required time predicted from a progress status to a time at which the update processing is started.

16. The method according to claim 10, wherein
the information processing device comprises a POS terminal.

17. The method according to claim 10, wherein
the information processing device comprises a plurality of POS terminals and a server.

18. A maintenance terminal, comprising:
a receiving component configured to receive, via a light receiving device, an end time of processing transmitted by visible light communication from an information processing device that executes the processing based on a preset processing procedure;
an alarm setting component for setting an alarm based on the end time received by the receiving component; and
a notification component for notifying when the alarm reaches a set time.

19. The maintenance terminal according to claim 18, further comprising:
a prediction component updates the end time according to a status of the processing executed.

20. The maintenance terminal according to claim 18, wherein
the maintenance terminal is a smartphone or tablet PC.
